(19) United States
(12) Patent Application Publication
(10) Pub. No.: US 2008/0256841 A1
(43) Pub. Date: Oct. 23, 2008

(54) Fishing Rig and Method of Use

(76) Inventor: James DeSpiegelaere, Keewatin, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/876,432

(22) Filed: Oct. 22, 2007

Related U.S. Application Data
(60) Provisional application No. 60/853,730, filed on Oct. 24, 2006.

(51) Int. Cl. A01K 91/04

(52) U.S. Cl. 43/44.83; 43/43.16; 43/44.2; 43/42.15

(57) ABSTRACT

A multiple hook fishing rig facilitating selective adjustability of hook spacing in order to accommodate bait of different sizes. A fishing rig includes a fishhook connected to a sliding line, with the sliding line being coupled to a primary line via a user positionable tension device. A method of using a fishing rig is also disclosed.

### RELATED APPLICATIONS

This application claims priority under 35 U.S.C. 119(e) from provisional U.S. Patent Application No. 60/853,730 filed Oct. 24, 2006 the contents of which are incorporated herein by reference.

### FIELD OF THE INVENTION

The present invention relates generally to fishhooks and more particularly to a hook rig for securing one or more fishhooks in an adjusted, predetermined position on a line or leader.

### BACKGROUND OF THE INVENTION

The double hook rigging of bait on a tackle line for catching game fish has been notoriously time consuming and frustrating for fishermen. The bait which is normally in the form of a small fish must be attached in such a way as to impart life-like action to the fish and to retain the bait in a very natural position to simulate the bait as it would normally appear if it were swimming. Several devices have been proposed in the past that have attempted to accomplish this result but all have failed for one reason or another.

Furthermore, even with riggings that have been created which do properly attach a bait fish to the same, the line used in making the rigs is normally relatively rigid so as to give the same the proper strength. This rigidity of the line, however, also prevents the bait from having a natural swimming appearance when trolling.

Trolling minnow rigs have been provided wherein fishhooks are mounted in tandem relation on a fish line leader, as by tying knots in the leader. No satisfactory way was provided for quickly, manually adjusting the spacing between the hooks to accommodate bate of varying sizes, or to provide requisite tensional connection between the bait and the spaced hooks.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### SUMMARY OF THE INVENTION

The present invention is directed to a fishing rig which allows a user to selectively adjust the spacing between one or more fishhooks in order to accommodate a variety of different baits sizes. In one embodiment, the fishing rig includes a fishhook connected to a sliding line, with the sliding line being coupled to a primary line via a user positionable tension device such as, for example, a slip knot.

An object of the present invention to overcome the deficiencies of the prior art described above by providing a fishing rig which is used to support bait fish in such a way that the same appears to be life-like when trolling.

It is a further object of the present invention to provide a fishing rig which is inexpensive to produce and which is relatively easy to utilize.

It is an even still further object of the present invention to provide a fishing rig which can be used to properly support bait fish of varying sizes.

It is an additional object of the present invention to provide a fishing rig which utilizes two hooks of any size and style that the angler chooses and which can be adjusted to rig baits of varying sizes.

### BRIEF DESCRIPTION OF THE DRAWINGS

FIG. 1 is a side elevational view of a fishing rig embodying the principles of the present invention.

FIG. 2 is a side elevational view of another embodiment of a fishing rig embodying principles of the present invention.

### DETAILED DESCRIPTION OF THE INVENTION

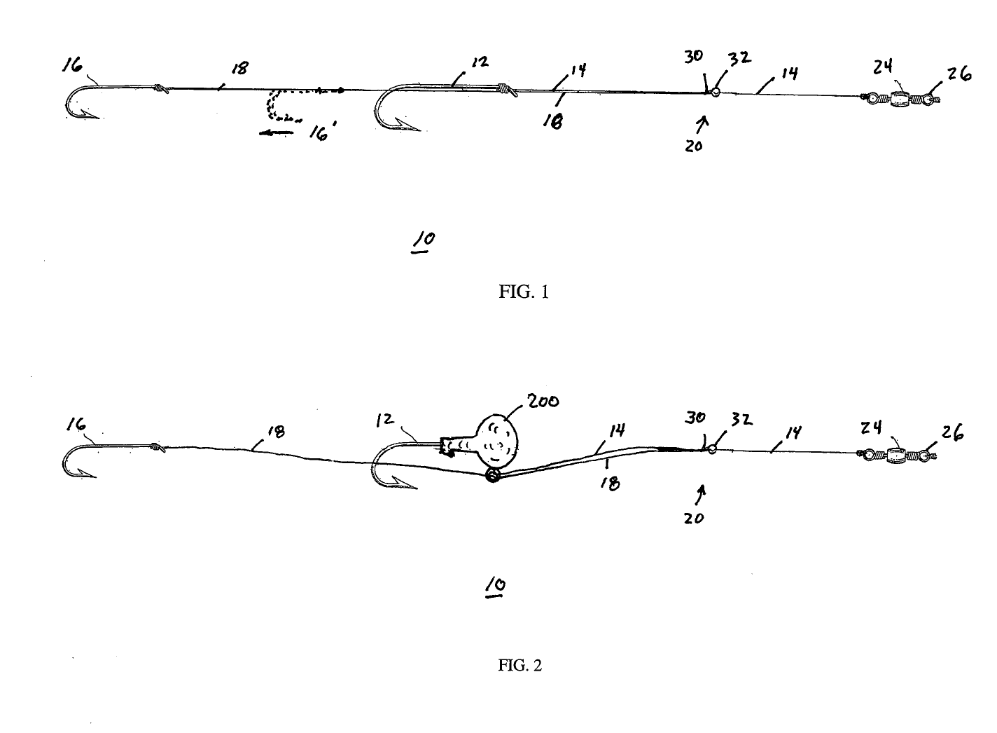

FIG. 1 shows a fishing rig constructed in accordance with the principles of the present invention and designated generally as 10. The rig 10 includes a stationary hook 12 connected at one end of a leader line 14, and a sliding hook 16 connected at one end of a secondary line 18. Secondary line 18 is connected via a tension device 20 to leader line 14 at a location away from stationary hook 12. Secondary line 18 is passed through an eyelet 22 of stationary hook 12 and connected in a sliding manner via tension device 20. A conventional swivel 24 may be connected to another end of leader line 14. A ring 26 is attached to the swivel 24 for connection to a fishing line in a known manner.

The length of lines 14, 18 may be chosen as desired depending on the size of the bait fish to be carried thereby. It has been found, however, that a length of between approximately 8 to 14 inches should satisfy substantially all needs. As will be seen, the tension device 20 allows for attaching the bait fish to the rig in an adjustable manner so that, if desired, a longer line can be utilized to hold even relatively small bait fish.

Hooks 12, 14 may assume a variety of configurations. For example, hooks 12, 14 may be single or multiple barb hooks. Hooks 12, 14 may include one or more weighted jig heads 200 as shown in FIG. 2.

Similarly, lines 14, 18 may include a variety of different materials or assemblies. For example, lines 14, 18 may be monofilament or multi-filament polymer lines. In another embodiment, lines 14, 18 may be of metallic material, such as metal leader lines.

Rig 10 may additionally include one or more spinners or beads (not shown) as readily appreciated by one of ordinary skill in the art. Additionally, rig 10 may include other types of end connections than swivel 24 and ring 26.

Tension device 20 slidably connects the sliding line 18 to stationary line 14. In one embodiment, tension device 20 includes a knot 30, such as a snell knot. Knot 30 may also be connected to a small bead 32 to assist in positioning the tensioning device 20 relative to stationary hook 12. While the snell knot and bead combination may be particularly desirable, other types of knots may be used to define tension device 20. Those of ordinary skill in the art will appreciate a variety of alternative knots useful for slidably connecting the lines 14, 18 together. In one embodiment, lines 14, 18 may be tied to respective hooks 12, 16 via 5 loop snell knots with knot 30 being a 3 loop snell knot.

In use of the rig 10, the sliding hook 16 is adjustable from or toward the stationary hook 12 by gripping the knot 30 and/or bead 32 between thumb and forefinger, and manually moving the knot 30 and bead 32. As a result, sliding hook 16 moves away from its original position as indicated by dotted line 16′. When the approximate required spacing of the hooks 12, 16 is accomplished, the barbed end of stationary hook 12 may be passed through the front portion of a bait, and then sliding hook 16 is adjusted with reference to stationary hook 12 so that the barbed end of hook 16 may be passed through a tail portion of the bait. If necessary, the sliding hook 16 may be further adjusted so that the bait will be securely positioned.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A fishing rig comprising:
a leader line;
a first hook having a shaft with a barb at one end and an eye at the other, with an end of said leader line being connected to said eye;
a sliding line; and
a second hook having a shaft with a barb at one end and an eye at the other, with an end of the sliding line being connected said eye of the second hook, wherein the sliding line passes through the eye of the first hook and is connected to the leader line via a tension device whereby said second hook is selectively movable along a length of said leader line.

2. The fishing rig of claim 1 wherein the leader line is tied to the eye of the first hook.

3. The fishing rig of claim 1 wherein the sliding line is tied to the eye of the second hook.

4. The fishing rig of claim 1 wherein the tension device comprises a knot formed from a portion of the sliding line.

5. The fishing rig of claim 4 wherein the tension device comprises a bead.

6. The fishing rig of claim 5 wherein the first hook is a weighted jig hook.

7. A fishing rig comprising:
a leader line;
a first hook having a shaft with a barb at one end and an eye at the other, with an end of said leader line being connected to said eye;
a sliding line;
a second hook having a shaft with a barb at one end and an eye at the other, and with an end of the sliding line being connected said eye of the second hook; and
means for limiting movement of the sliding line, wherein the sliding line passes through the eye of the first hook and is connected to the leader line via said means, and whereby said second hook is selectively movable along a length of said leader line.

8. The fishing rig of claim 7 wherein the leader line is tied to the eye of the first hook.

9. The fishing rig of claim 7 wherein the sliding line is tied to the eye of the second hook.

10. The fishing rig of claim 7 wherein the tension device comprises a knot formed from a portion of the sliding line.

11. The fishing rig of claim 10 wherein the tension device comprises a bead.

12. The fishing rig of claim 11 wherein the knot and the bead are tied together.

13. A fishing rig comprising:
a leader line tied at one end to a first hook;
a sliding line passing through an eye of the first hook and being tied at one end to a second hook; and
a bead element and sliding knot combination defined at an opposite end of the second hook, said sliding knob tending to restrain movement of the sliding line relative to the leader line.

14. The fishing rig of claim 13 wherein the knot is formed from a portion of the sliding line.

15. The fishing rig of claim 14 wherein the knot and bead element are tied together.

16. A method of fishing comprising:
providing a leader line, a first hook having a shaft with a barb at one end and an eye at the other, with an end of said leader line being connected to said eye, a sliding line, and a second hook having a shaft with a barb at one end and an eye at the other, with an end of the sliding line being connected said eye of the second hook, wherein the sliding line passes through the eye of the first hook and is connected to the leader line via a tension device;
engaging the first hook to a bait;
grasping the tension device and moving the sliding line and second hook away from or toward the first hook to a new location dependent on a size of the bait;
releasing the tension device, with the tension device tending to restrain the second hook from movement away from the new location; and
engaging the second hook to the bait.

17. The method of claim 16 wherein the tension device comprises a bead element and said grasping includes contacting and moving the bead element along a length of the leader line.

18. The method of claim 16 wherein the tension device comprises a knot and a bead element, and said grasping includes contacting and moving the knot and bead element along a length of the leader line.

19. The method of claim 16 further comprising:
securing said leader line to another line.

20. The method of claim 19 wherein said securing includes connecting via a swivel/ring combination.
